(19) United States
(12) Patent Application Publication
(10) Pub. No.: US 2005/0175977 A1
(43) Pub. Date: Aug. 11, 2005

(54) Hemoglobin isolation and preparation of glycosylated hemoglobin

(76) Inventors: Alan H. Posner, Davie, FL (US); David L. Reichenbach, Pembroke Pines, FL (US)

Correspondence Address: Donald W. Meeker;Patent Agent, 924 EAST OCEAN FRONT #E, NEWPORT BEACH, CA, 92661, US

(21) Appl. No.: 10/775,491

(22) Filed: Feb. 10, 2004

(51) Int. Cl. A01N 1/02

(52) U.S. Cl. 435/2

(57) ABSTRACT

A method of treating of glycosylated hemoglobin and in particular the process of hemoglobin isolation and preparation of a stable glycosylated hemoglobin in which the glycosylated hemoglobin remains liquid. The method comprises steps including separating human red blood cells from anti-coagulated blood, washing the human red blood cells with physiological saline and centrifuging the red blood cells and aspirating and discarding a resulting supernatant and white blood cell layer, lysing the packed red blood cells, mixing and freezing the cell/water mixture, defrosting, centrifuging, filtering and saving the supernatant, heating the supernatant, diafiltering the adjusting the hemolysate so that a final hemoglobin concentration is within specified limits. Additives may include potassium cyanide, carbon monoxide, and appropriate preservatives.

### BACKGROUND OF THE INVENTION

1. Field of the Invention

This invention relates to the treatment of glycosylated hemoglobin and in particular the process of hemoglobin isolation and preparation of stable liquid glycosylated hemoglobin.

2. Description of the Prior Art

Glycosylated Hemoglobin is used as an indicator of how well a diabetic patient has been controlling his/her glucose over the past three months. A glucose measurement only gives a picture of what is happening at the time the sample was collected. Glycosylated hemoglobin is formed in the red blood cell by the non-enzymatic reaction between glucose and hemoglobin. The higher the glucose concentration the more glycosylated hemoglobin that is formed. The glycosylated hemoglobin molecule is stable. As the average red blood cell has a life span of 90 days, the measurement of glycosylated hemoglobin gives a picture of what the glucose concentration was over the past 90 days. If the glycosylated hemoglobin is high, it means the patient has not been controlling their glucose concentration very well and this patient is going to be subjected to the long term consequences of being a poorly controlled diabetic.

It is important to have a “control” so that laboratories can be assured that their assay is performing properly and that the patient results that they report out are valid. This control can also be used in Proficiency Testing schemes. This is where ‘authorized agencies’ send samples of the same material to laboratories. The laboratory results are then compared and graded.

Prior art processes do not seem to produce a stable liquid product using a simple process.

U.S. Pat. No. 4,448,888, issued May 15, 1984 to Bleile, provides an artificially constituted storage-stable hemoglobin compositions for use in the temperature correction of a cation exchange column chromatographic assay for hemoglobin A.sub.1 or A.sub.1c in a sample of human blood. The relative amounts of hemoglobin components in the composition conform approximately to the following formula:
y=mx+b
where y=weight percent A.sub.1c with respect to A.sub.1
x=weight percent A.sub.1 with respect to total hemoglobin
m=−1.7 and b=85 when x<10, and
m=−1.2 and b=80 when x>10.

The compositions when analyzed in a cation exchange assay produce a result which varies with temperature in substantially the same manner as that from a true sample of human blood.

U.S. Pat. No. 5,169,937, issued Dec. 8, 1992 to Smith, shows methods of preparing glucitollysine-hemoglobin from a sample of glucohemoglobin containing stable and labile glucohemoglobins and for assaying for the presence of stable glucohemoglobin are disclosed, as is a diagnostic assay system useful for carrying out the methods.

U.S. Pat. No. 5,352,773, issued on Oct. 4, 1994 to Kandler, depicts an invention which relates to a stable hemoglobin based composition having sufficiently low levels of methemoglobin to effectively function as an oxygen carrying solution upon administration to a patient made by the process comprising: a) adding an oxygenated or deoxygenated form of said blood substitute to an oxygen impermeable package, and b) storing said container at from between 5.degree. C. to 45.degree. C. for sufficient time to permit the autoreduction of methemoglobin. The stable hemoglobin based composition includes hemoglobin, modified hemoglobin. and/or encapsulated hemoglobin. To effectively function as an oxygen carrying solution upon administration to a patient, the stable hemoglobin based solution cannot have greater than about 50% of said hemoglobin based solution in the methemoglobin form but, preferably no more than about 15%. The invention further relates to a method to store a stable oxygen carrying solution according to the above discussed process.

U.S. Pat. No. 5,589,393, issued Dec. 31, 1996 to Fiechtner, describes an invention which is a rapid, continuous test for glycated hemoglobin using a non-equilibrium affinity binding method. Agarose beads derivatized with 3-aminophenylboronic acid specifically bind glycated hemoglobin. This solid phase is incorporated into a sample processor card, modified to mix and to separate the test solution from the solid phase prior to absorbance readings. Two absorbance readings are made on the test solution, one immediately after mixing the reagent/diluent with the specimen, and one after a significant amount of binding has occurred. A linear correlation between total glycated hemoglobin and hemoglobin A.sub.1c permits standardization and reporting of units equivalent to % hemoglobin A.sub.1c. Stable glycated hemoglobin solutions for use as standards in the assay, and a method for preparing the standards are also disclosed.

U.S. Pat. No. 5,929,031, issued Jul. 27, 1999 to Kerwin, illustrates an invention that relates to storage stable hemoglobin solutions which contain partially deoxygenated and surprisingly low amounts of reducing agents. Methods for preparing such storage stable hemoglobin solutions are also provided as well as a systems for storing the solutions.

What is needed is a simple method for producing a stable glycosylated hemoglobin.

### SUMMARY OF THE INVENTION

One object for carrying out the method or process of the present invention is to manufacture a liquid stable glycosylated hemoglobin (Hemoglobin A1C) control (and/or calibrant) so that laboratories can be assured that their assay is performing properly and that the patient results that they report out are valid.

A corollary object of the present invention is to produce a liquid stable glycosylated hemoglobin (Hemoglobin A1C) control (and/or calibrant) which can also be used in Proficiency Testing schemes. This is where ‘authorized agencies’ send samples of the same material to laboratories. The laboratory results are then compared and graded.

Another object of the present invention is to provide a method or process for the manufacture of hemoglobin isolation and glycosylated hemoglobin (A1c) preparation that is a relatively simple process for producing a stable product.

An additional object of the present invention is to produce a product by the method of the present invention that seems to be more stable than some of the current competitive products.

In brief, the method of the present invention has to do with the preparation of a Liquid Stable Glycosylated Hemoglobin (Hemoglobin A1C) control (and /or calibrant). In the present method of hemoglobin isolation and glycosylated hemoglobin (A1c) preparation, human red blood cells (RBC, Erythrocytes) are separated from anti-coagulated blood and washed 3 times with an equal volume of physiological saline. After each wash the RBC's are centrifuged to pack down the RBC's. The resulting supernatant, saline and white blood cell layer are aspirated and discarded.

After the last wash, the packed cells are then lysed by adding purified water. Potassium cyanide maybe added to the solution to ensure that the concentration of methemoglobin is kept to a minimum. The cell/water mixture is mixed and then frozen.

The frozen lysed erythrocytes are defrosted, and the hemolysate is then centrifuged. The resulting supernatant is saved and filtered. The supernatant is then heated to ensure that the labile fraction of hemoglobin A1c is low. The hemolysate is then either
1. Subjected to diafiltration to remove all the small molecules, especially glucose, and adjusted so that the final hemoglobin concentration is within specified limits. A cyanide salt (i.e. potassium cyanide) may be added; or
2. Has glucose or other appropriate sugar added to it and placed at 37° C. to allow glycosylation to proceed. When the concentration of glycosylated hemoglobin had reached the target concentration the hemolysate is then diafiltered to remove all the small molecules, especially the glucose, and adjusted so that the final hemoglobin concentration is within specification. The resulting hemolysate may be incubated at 37° C. to ensure that the labile fraction of A1c is low. A cyanide salt (i.e. potassium cyanide) may be added.

To ensure the physical appearance of the product, the hemoglobin may be treated with Carbon Monoxide.

Appropriated preservatives are added during the processing to prevent microbial contamination and growth.

Under laboratory testing of the present invention, several lots (Normal and Abnormal ((elevated)) of this product were prepared. From a search of the literature, the present invention appears to have a unique manufacturing process that allows the product of the present invention to be stable as a liquid at 4° C. vs. either a lyophilized or frozen product.

An advantage in carrying out the method or process of the present invention is in manufacturing a liquid stable glycosylated hemoglobin (Hemoglobin A1C) control (and/or calibrant) so that laboratories can be assured that their assay is performing properly and that the patient results that they report out are valid.

Another advantage of the present invention is in producing a liquid stable glycosylated hemoglobin (Hemoglobin A1C) control (and/or calibrant) which can also be used in Proficiency Testing schemes. This is where ‘authorized agencies’ send samples of the same material to laboratories. The laboratory results are then compared and graded.

An additional advantage of the present invention is to provide a method or process for the manufacture of hemoglobin isolation and glycosylated hemoglobin (A1c) preparation that is a relatively simple process for producing a stable product.

One more advantage of the present invention is to produce a product by the method of the present invention that seems to be more stable than some of the current competitive products.

### BEST MODE FOR CARRYING OUT THE INVENTION

A method for the preparation of a liquid stable glycosylated hemoglobin (Hemoglobin A1C) control and calibrant comprises:
A first step of separating human red blood cells (RBC, Erythrocytes) from anti-coagulated blood.
A second step of washing the human red blood cells three times with an equal volume of physiological saline, including after each washing centrifuging the red blood cells to pack them down, and aspirating and discarding the resulting supernatant, and white blood cell layer (Buffy coat).
A third step of lysing the packed red blood cells by adding a quantity of purified water to produce a cell/water mixture The third step further comprises adding a quantity of a cyanide salt (including but not restricted to potassium cyanide) to the solution to ensure that the concentration of methemoglobin is kept to a minimum.
A fourth step of mixing and freezing the cell/water mixture to produce frozen lysed red blood cells.
A fifth step of defrosting the frozen lysed red blood cells to produce a hemolysate.
A sixth step of centrifuging the hemolysate to produce a resulting supernatant.
A seventh step of filtering and saving the supernatant.
An eighth step of heating the supernatant to ensure that a labile fraction of hemoglobin A1c is low.
A ninth step of diafiltering the hemolysate to remove all the small molecules, especially glucose.
A tenth step of adjusting the hemolysate so that a final hemoglobin concentration is within specified limits.
An eleventh step of adding a quantity of potassium cyanide, a quantity of carbon monoxide to ensure the physical appearance of the product and a quantity of appropriated preservatives during the processing to prevent microbial contamination and growth.

Alternately, the ninth step comprises adding glucose or any other suitable mono saccharide or disaccharide to the hemolysate prior to the diafiltering and placing the sugar and hemolysate at between 4° C. and 45° C. to allow glycosylation to proceed until a concentration of glycosylated hemoglobin has reached a target concentration. Then proceed with the drafiltration to remove small molecules especially the sugar. Step 10 is to adjust the hemoglobin concentration to be within the specific target range. Next, proceed with the eleventh step comprising incubating the hemolysate at 37° C. to ensure that a labile fraction of A1c is low. A twelfth step comprising adding a quantity of a cyanide salt, if necessary, a quantity of carbon monoxide to ensure the physical appearance of the product and a quantity of appropriate preservatives during the processing to prevent microbial contamination and growth.

The method produces a liquid stable glycosylated hemoglobin (Hemoglobin A1C) control and calibrant.

It is understood that the preceding description is given merely by way of illustration and not in limitation of the invention and that various modifications may be made thereto without departing from the spirit of the invention as claimed.

1. A method for the preparation of a liquid stable glycosylated hemoglobin (Hemoglobin A1C) control and calibrant, the method comprising:
a first step of separating human red blood cells (RBC, Erythrocytes) from anti-coagulated blood;
a second step of washing the human red blood cells 3 times with an equal volume of physiological saline, including after each washing centrifuging the red blood cells to pack them down, and aspirating and discarding a resulting supernatant and white blood cells;
a third step of lysing the packed red blood cells by adding a quantity of purified water to produce a cell/water mixture;
a fourth step of mixing and freezing the cell/water mixture to produce frozen lysed red blood cells;
a fifth step of defrosting the frozen lysed red blood cells to produce a hemolysate;
a sixth step of centrifuging the hemolysate to produce a resulting supernatant,
a seventh step of filtering and saving the supernatant;
an eighth step of heating the supernatant to ensure that a labile fraction of hemoglobin A1c is low;
a ninth step of diafiltering the hemolysate to remove all the small molecules, especially glucose; and
a tenth step of adjusting the hemolysate so that a final hemoglobin concentration is within specified limits.

2. The method of claim 1 further comprising an eleventh step of adding a quantity of a cyanide salt.

3. The method of claim 1 further comprising an eleventh step of adding a quantity of carbon monoxide to ensure the physical appearance of the product.

4. The method of claim 1 further comprising adding a quantity of appropriated preservatives during the processing to prevent microbial contamination and growth.

5. The method of claim 1 wherein the third step further comprises adding a quantity of a cyanide salt to the solution to ensure that a concentration of methemoglobin is kept to a minimum.

6. The method of claim 1 wherein the ninth step further comprises adding glucose to the hemolysate prior to the diafiltering and placing the glucose and hemolysate at 37° C. to allow glycosylation to proceed until a concentration of glycosylated hemoglobin has reached a target concentration; and
an eleventh step of incubating the hemolysate at 37° C. to ensure that the labile fraction of A1c is low.

7. The method of claim 6 a twelfth step of adding a quantity of a cyanide salt.

8. The method of claim 6 further comprising a twelfth step of adding a quantity of carbon monoxide to ensure the physical appearance of the product.

9. The method of claim 6 further comprising adding a quantity of appropriated preservatives during the processing to prevent microbial contamination and growth.
